(19) United States
(12) Patent Application Publication
(10) Pub. No.: US 2006/0159589 A1
(43) Pub. Date: Jul. 20, 2006

(54) Bacteria sensor and method

(76) Inventor: Indu Saxena, Torrance, CA (US)

Correspondence Address: LAWRENCE S. COHEN, SUITE 1220, 10960 WILSHIRE BLVD., LOS ANGELES, CA, 90024, US

(21) Appl. No.: 11/035,501

(22) Filed: Jan. 14, 2005

(51) Int. Cl. G01N 21/64

(52) U.S. Cl. 422/82.08

(57) ABSTRACT

Bacteria accumulations on the interior walls of a fluid conduit are detected by placing a bacterial target substrate the conduit. The substrate structured to allow bacteria to colonize it at at least the rate of accumulation expected on the conduit walls or at an accelerated rate in order to preempt normal bacteria accumulation on the walls. A bacteria getter may be used to accelerate bacterial colonization of the substrate. An excitation signal interrogating the substrate causes autofluorescence in the presence of bacteria, specifically from NADH and/or NADPH present. The autofluorescent emission is transmitted to a detector and processor. In one system when the presence of bacteria at a preset level is detected there is initiated a diversion of the fluid into an auxiliary subsystem during which the primary subsystem is remediated.

### FIELD OF THE INVENTION

This invention relates to the detection of bacteria accumulations (referred to herein as biofilm) on the interior walls of tubes or conduits carrying fluids in which bacteria are entrained.

### BACKGROUND OF THE INVENTION

There is a wide range of situations where biofilm growth is a problem. A biofilm detection instrument will have numerous applications. Conventional procedures, where samples must be taken from a possibly colonized area and analyzed by trained personnel are slow and expensive.

Water lines frequently accumulate bacteria on the interior walls of the line. When used in medical and/or dental or other hygienic related application the accumulation of bacteria on surfaces often leads to user infections and, for remediation, equipment down time.

The problem is particularly noticeable, for example, in dental offices where water lines are used in oral irrigation systems. Bacteria freely moving in the water can be removed by filters and cause no problem. But, the problem arises when some of the bacteria starts to accumulate as biofilm at some point along the interior wall of the line.

Typically bacterial accumulation tends to occur first at an obstruction such as a bend or discontinuity in the line or a change in the geometry of the line as might be introduced by a clamp, joint or some connection to the line.

Also fluid line used in hemodialysis, similar serious problems exist.

Also, the presence of bacteria in food processing equipment also causes biofilm deposits at critical points such as pumps, valves, bends, and heat exchangers.

There are numerous other cases where bacteria in fluid lines creates risk of passing bacteria downstream to end users caused by biofilm.

There is a need for technology to avoid the growth of excessive biofilm and to remediate it in fluid systems. A real time, on-line system and d method has not been available.

The present invention provides an apparatus and method for detecting the growth and presence of biofilm and for on-line remediation.

### BRIEF DESCRIPTION OF THE INVENTION

The invention is an apparatus and method for fiber optic biological detection of biofilm bacterial contamination of fluid carrying lines, in particular water lines. In one aspect the invention comprehends a low cost easy to use fiber optic based system, which can monitor biofouling of water lines or other fluid carrying lines at one or more points simultaneously.

In accordance with one aspect of the invention light beam of selected wavelength is directed at a selected site at which the presence of biofilm is to be detected, the light being of a nature to cause autofluorescence of bacteria at the site (excitation light). The autofluorescence is detected indicating the presence of live bacteria. The autofluorescence is referred to as emission light. In a further aspect, a substrate is placed in a selected location in a fluid line in which the presence of bacterial biofilm accumulation is desired to be detected. The substrate acts as a colonization site for bacteria. A fiber optic cable is placed a working distance from the substrate. One or more optical fibers in the cable carry excitation light is directed onto the substrate. The excitation light is of a selected wavelength to cause autofluorescence of bacteria. In the presence of bacteria, the autofluorescence will occur and the consequent excitation light or signal is detected by other optical fibers, preferably in the same cable and transmitted to a detection unit.

The substrate should be of a material that will not itself autofluoresce in the presence of the excitation light directed at the substrate. It should also be of a material that will allow colonization of bacteria at a rate at least as fast as, and preferably faster than, the accumulation of bacteria on the fluid line. In this way remediation can be planned in advance of serious excess biofilm presence in the fluid line.

The amount of biofilm accumulation on the substrate can be measured by the relative intensity of the emission signal.

In accordance with one aspect of this invention, the substrate comprises a bacteria getter configured to attract bacteria at a rate that is relatively fast compared to the rate at which line obstructions or geometric changes attract bacteria. A bacteria getter refers to special structure that will capture, attract or otherwise cause the accumulation of bacteria other than by the normal colonization of a surface. For example a fine mesh through which bacteria cannot pass would be regarded as a bacteria getter. Also a substrate treated with a bacteria attracting chemistry such as agar would be similarly regarded as a bacteria getter. It is noted that in some applications the introduction of an extraneous chemistry would not be acceptable.

The accumulation of bacteria on the substrate results in autofluorescence at a frequency different from the frequency of light directed at the substrate. Light is directed at the substrate to sample for bacteria accumulation. A detector operatively coupled to the substrate responds to the light at the autofluorescence frequency to provide a signal indicative of the presence of bacteria.

However, the excitation light does create an undesirable noise level in the returning emission light and therefor a filter in employed to remove the returning excitation light.

In one aspect, the emission signal provided by the detector is operative to activate a mechanism for diverting fluid flow into a second fluid line and for introducing a bactericidal agent into the first fluid line. Alternatively, an infrared energy delivery system can be used to heat the substrate at a temperature and for a time to destroy the bacteria.

### BRIEF DESCRIPTION OF THE DRAWINGS

FIG. 1 is a schematic diagram of an optical fiber biofilm sensor system in accordance with the principles of this invention including a bacterial target substrate in relation with an interrogation fiber.

FIG. 2 is a schematic sectional side view of a portion of the system of FIG. 1 showing the detail of the interrogation fiber end.

FIG. 3 is a schematic end view of a portion of one embodiment of an optical fiber cable used in the system.

FIGS. 4, 5 and 6 are schematic side views of alternate configurations of the arrangement of the optical fiber cable and the bacterial target substrate in accordance with the principles of this invention.

FIG. 7 is a schematic diagram of a diverter system for changing the fluid path from a contaminated to a non-contaminated path in order to remediate a system without loss of operation.

FIG. 8 is a flow diagram for the operation of the system FIG. 7.

### DETAILED DESCRIPTION OF ILLUSTRATIVE EMBODIMENTS OF THIS INVENTION

Attached to this description is a document FINAL REPORT, the entire content of which is incorporated by reference into the description.

Bacteria are one of natures most abundant and viable life forms. Sessile forms of bacteria form biofilms on surfaces and can nurture additional pathogens. These biofilms can cause major health problems when infesting man-made medical delivery systems that should ideally, be sterile. Further, the infestation of bacteria on fluid lines of many types of systems is undesirable. At least, in many systems, it is desirable to be able to monitor the accumulation of bacteria on the conduit surfaces and to remediate the collection of bacteria in the conduit. Therefore the on-line in-situ detection of biofilm accumulation and measurement of the degree of biofilm accumulation is useful. For example systems such as water delivered by dental equipment, and in hemodialysis facilities should be monitored for bacteria accumulation and when appropriate remediated.

The invention as described herein is an apparatus and method for on-line, in-situ detection of bacteria accumulation on a substrate placed in the fluid line by means of a bacterial target such as a bacteria collecting substrate and an excitation light that is delivered by one or more optical fibers that will cause autofluorescence of the bacteria and an optical fiber receiver that will receive the autofluorescence emission signal. The excitation optical fiber carrying the excitation signal and the receiving optical fiber carrying the emission signal extend from a source and a receiver/processor respectively. The source provides a light of appropriate frequency to cause the autofluorescent response from the bacteria (it is again noted that the autofluorescence is from NADH and/or NADPH present with the bacteria). The receiver/processor receives the emission signal and may be equipped to monitor and record signals over time when the system is configured for automatic operation; and may also be equipped to measure different intensity of the emission signal and compare it to a reference signal and to signals earlier in time to enable tracking or to a signal level set as an alarm level.

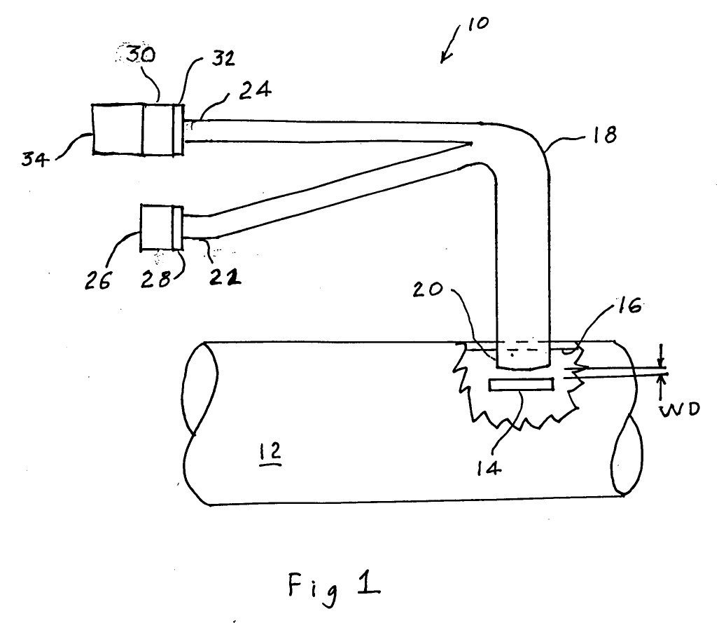

FIG. 1 shows an apparatus 10 having a fluid line 12 with a bacterial target substrate 14 located close to the interior surface wall 16 of the fluid line 12. A bifurcated optical fiber cable 18 carries at least one and preferable several optical fibers for transmitting the excitation signal (delivering optical fibers) and also at least one and preferable several optical fibers for carrying the emission signal (responding optical fibers). The distal end 20 of the bifurcated optical fiber cable 18 is located inside the fluid line 12 with the end 20 placed a working distance (WD) from the bacterial target substrate 12. The working distance is a distance sufficient to deliver the interrogating excitation light to bacteria on the bacterial target substrate 14 from the delivering optical fibers to cause autofluorescence and to effectively receive the autofluorescent emissions. in the case of the responding optical fibers. Of course in some configurations, the working distance for the delivering optical fibers and for the responding optical fibers may differ; but the term working distance is intended to mean a distance with respect to each that works.

The optical fiber cable 18 has first and second proximal ends 22 and 24. The proximal end 22 is connected to a light source 26 which may be an LED or a laser. A short pass filter 28 is interposed between the light source and the delivering optical fibers in order to filter out any light from the light source 26 that is in the range of the emission signal. The proximal end 24 is connected to a photodetector 30. A long pass filter 32 is interposed between the emission optical fiber proximal end 24 and the photodetector 30 in order to filter out any excitation light that may have entered the responding optical fibers. In operation, light from source 20 is directed at the bacterial target substrate 14 and autofluorescent emissions from bacteria on the bacterial target substrate 14 is detected by photodetector 30. The emission signal can be further measured and processed by the receiver/processor 34 that may include circuitry for additional processing and a specially programmed CPU for operating an algorithm to, for example, activate an alarm, an automatic diverter to substitute an alternative fluid line, to shut off the fluid process, etc.

The effectiveness of the system depends on the structure and location of the bacterial target substrate 14 to provide a preferred bacteria accumulation site and the structure and location of distal end 20 with respect to the substrate 14 to transmit light from the bacterial target substrate 14 at a frequency which is a function of the presence of bacteria there. It is considered preferable that the bacterial target substrate 14 be close to the wall 16 of the fluid line 12 in order to be exposed to slower moving fluid.

In one embodiment the bifurcated optical fiber 18 is an optical fiber cable having a number of optical fibers. One or more, preferably several, of the optical fibers are arranged to receive at their proximal end 22 the excitation signal; these are called excitation optical fibers. One or more, preferably several of the optical fibers are arranged to receive and deliver the autofluorescent signal, the emission signal to the proximal end 24; these are called emission optical fibers. At the distal end 20 the excitation fiber(s) and the emission fiber(s) are spaced an appropriate working distance from the bacterial target substrate 14 area to perform their respective functions.

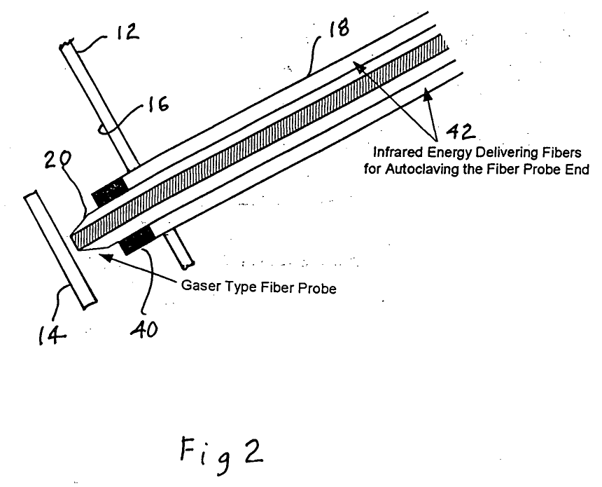

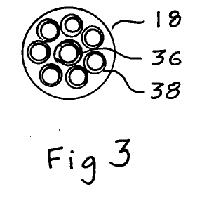

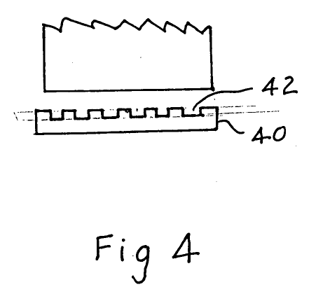

FIGS. 2 and 3 show views of the distal end 20 of the optical fiber cable 18 as well as the location of the distal end with respect to the bacterial target substrate 14. In FIG. 4 an exemplary configuration is a single excitation fiber 36 centrally located and a plurality of emission fibers 38 surrounding the excitation fiber 36. FIGS. 4 through 6 show alternative bacterial target structures.

FIG. 4 shows a schematic side view of a bacterial target substrate 40 in accordance with the principles of this invention. The bacterial target substrate 40 comprises a surface 42 of which is configured to include traps with feature size of from one to one hundred micrometers in a periodic or an aperiodic arrangement to enhance the colonization rate of bacteria.

FIG. 2 shows a distal end 20 of an optical fiber cable 18 comprising a fiber bundle, the end view of which is shown in FIG. 3. The bundle includes a central excitation fiber 36 (although it is preferable to have a plurality of excitation fibers) through which the excitation signal is transmitted from source 28. The excitation signal from source 28 has a frequency in a range of from about 290 nm to about 420 nm, more preferably from about 340 nm to about 410 nm. In the signal path the short pass (excitation) filter 28 is between the excitation light source 26 and the bacterial target substrate 14 and is shown illustratively on the surface of the source (LED or laser).

Light from source 28 impinges substrate 14 which when bacteria is present responds by autofluorescence to emit light having an emission peak between 450 and 460 nanometers. Detector 30 of FIG. 1 measures the bacteria by autofluorescent emission from hydrogenated nicotinamide adenine dinucleotide (NADH) and/or from hydrogenated nicotinamide adenine dinucleotide phosphate (NADPH) emission by detecting the totality of the light intensity in the wavelength range of 420 to 550 nanometers; thereby defining an emission signal whose intensity has a relationship with the amount of bacteria on the substrate. To this end, detector 30 includes a long pass (emission) filter 32, shown in FIG. 1, with a cut off between 400 and 440 nanometers.

The light from substrate 14 is transmitted to detector 30 via emission optical fibers 38 shown in FIG. 3 and advantageously configured as a fiber bundle around the centrally located excitation optical fiber 36 as shown in FIG. 3.

Another preferred configuration of the optical fibers in the optical fiber cable is a pseudo-random configuration in which the excitation fibers and the emission fibers are intermixed either in a pattern such as concentric circles or more randomly. The arrangement of the fibers at the distal end is what is of concern; their arrangement path getting there is not important.

The working distance (WD) between distal end 20 of the fiber cable 18 and the substrate 14 is approximately 0.5 millimeters (mm) for an optical fiber distal end consisting of randomly arranged fibers of forty micrometers of NA=0.5 and a bundle diameter of 0.18 inch. For practical embodiments herein, a working distance typically lies between 0.1 mm and 10 mm.

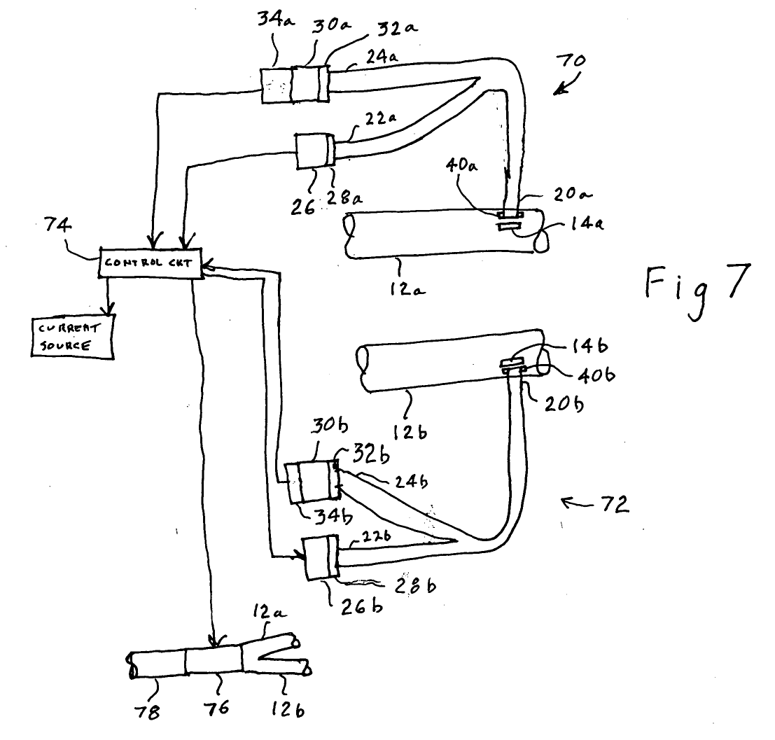

FIG. 7 is a schematic diagram of a system of the type shown in FIG. 1 further including an auxiliary fluid line, a diverter for redirecting fluid flow from one fluid line to another and a heating mechanism for eliminating bacteria from the on line path. For convenience, like reference numbers are used in FIG. 7 corresponding to designations of like elements in FIG. 1 with subscripts to differentiate primary (on-line) and alternative (off line) subsystems.

Specifically, FIG. 7 shows a bacteria sensing system including, illustratively, an on-line or primary subsystem 70 and an off line or alternative subsystem 72. Each subsystems, 70 and 72 of the system is associated with a water line 12a and 12b respectively. Each subsystem also includes a bacterial target substrate 14a and 14b respectively. Excitation light from source 26a or 26b is directed at the respective substrate 14a and 14b depending on which subsystem is in operation (hereinafter assumed to be subsystem 70). Signal response from substrate 14a is directed at photodetector 30a through a long pass filter 32a (32b for subsystem 72) and is processed by processor 34a (34b for subsystem 72). The presence of a signal at a frequency representative of the presence of bacteria at substrate 14a, results in photodetector 30a and processor 34a signaling control circuit 74 to activate diverter 76 to divert the fluid flow from fluid source 78 to from fluid line 12a to fluid line 12b thus taking subsystem 70 off-line. Of course, the reverse process switches from subsystem 72 to subsystem 70. But in some cases subsystem 72 may be configured as a temporary subsystem until the primary subsystem 70 has been remediated and can be put back on line.

Each of the fluid lines 12a and 12b is associated with a sensing system operating as described hereinbefore in connection with FIG. 1. As shown in FIG. 2, each sensing system includes an optical fiber, illustratively, with a metallic collar 40 at distal end 20 as shown in FIG. 2. Infrared delivery fibers 42 are coupled to collar 40. Control circuit 74 responds to a signal from the processor 34a to activate a source of infrared energy to heat collar 40 to a temperature and for a time to eliminate bacteria on the associated bacterial target substrate 14a (or 14b for subsystem 72).

The off-line subsystem 72 of FIG. 7 thus is readied for on-line operation if and when photodetector 30a receives a signal indicating the presence of bacteria on the substrate 14a and the processor 34a recognizes a sufficient level of bacterial presence as indicated by the intensity of the emission signal to trigger the procedure of taking the primary subsystem 70 offline and substituting the alternative subsystem 72. At the same time, the remediation process is also triggered. When remediation is triggered near infrared light (NIR), at wavelength 980 nm or 1.06 um, is send down the optical fibers 42 (FIG. 2). As this is a water absorption line, the biofilm on the substrate 14a which is mainly water will heat up. The temperature is measured by and with a thermocouple controlled to hold temperature at 125 degrees C. and to stop heating. This can be accomplished by measuring temperature with a thermocouple or with fluorescence emitted by a phosphor located at the distal end 20a where fluorescence intensity is calibrated against temperature.

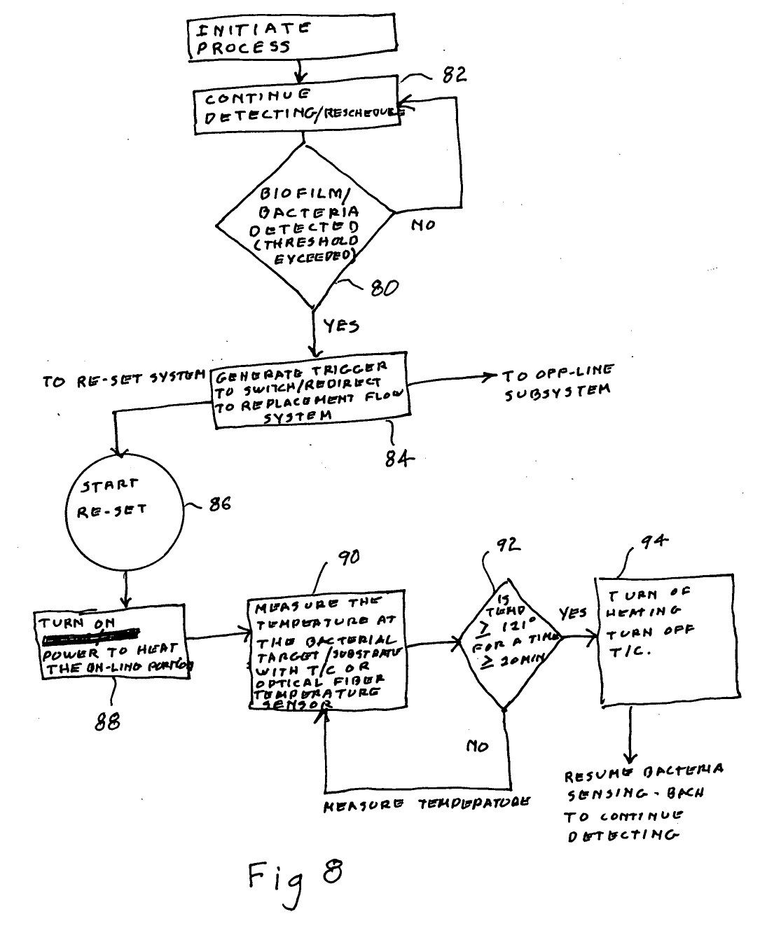

FIG. 8 is a flow diagram of the operation of the system of FIG. 7. Excitation light from source 26a, (in the assumed on-line subsystem 70) is generated in accordance with a user-selected schedule to test for the presence of bacteria as indicated in block 80 of FIG. 8. If no response is detected, the detection operation continues or is rescheduled as indicated by block 82.

If bacteria is detected, a signal is generated to divert fluid flow to the sterile off-line subsystem as indicated in block 84.

The signal also initiates the sterilization of the previously on-line subsystem substrate as indicated in block 86 resulting in the activation of an illustrative infrared (laser, LED - - - ) source to heat the contaminated substrate as indicated in block 88.

The temperature at the distal end of the optical fiber may be measured, with a T/C or other sensor, as indicated in block 90 to ensure that a temperature of at least 125 degree Celsius has been reached for at least 20 minutes as indicated in (decision) block 92.

If the minimum temperature and time has been reached, the infrared source is turned off as indicated by block 94 and the bacteria detection operation is resumed for the (now) on-line subsystem. If not, the temperature sensing operation continues.

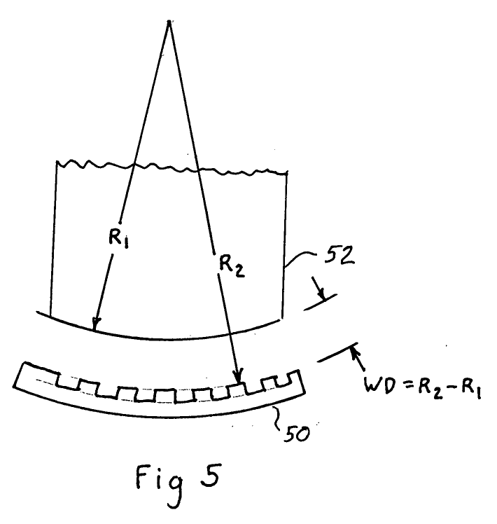

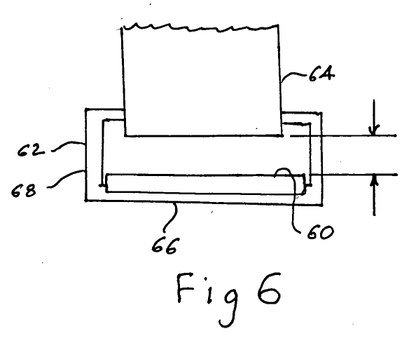

FIGS. 4 and 5 show illustrative configurations for a bacterial target substrate for the system of FIG. 1 or FIG. 7. FIG. 4 shows a substrate 40 with a periodic or random microstructure as discussed hereinbefore. FIG. 5 shows a substrate 50 with a curved surface of radius R2 and the distal end 52 of the optical fiber cable having a radius R1; with a working distance, WD, being R2-R1. FIG. 6 shows a substrate 60 with a flat surface of dark (no shine) material such as polycarbonate, black silicone or anodized aluminum. A fiber associated with such a substrate conveniently has a support and distance structure 62 attached to the distal end 64 of the fiber cable and having a table 66 on which is mounted the substrate 60 and locating arms 68 to establish the working distance.

Regardless of the probe configuration, it is preferable to mount it near the interior surface of the fluid line. If the fluid line is transparent to the frequency used for detection, placement of the probe is straightforward. On the other hand, if the fluid line is not transparent, the probe has to be mounted on a transparent patch and secured about an aperture in the line wall.

The detection of a signal representative if the presence of bacteria has been described in terms of a photodetector. Alternative detection techniques also are useful such as a spectrometer comprising one or more grating monochrometers and one or more photodetectors.

Alternative techniques for measuring the temperature of the probe during sterilization are available. One illustrative technique utilizes a phosphor coated on the probe substrate. The phosphor emits a fluorescence of an intensity which is a function of its temperature and which can be calibrated for the system.

The various components of FIG. 1 or FIG. 7 may be any such components capable of operation as described and the components described herein are only illustrative. Those skilled in the art are capable of various modifications of the invention herein and the following claims are of a scope intended to encompass such modifications.

What is claimed is:

1. An apparatus for the detection of biofouling in a fluid line comprising;
a bacterial target comprising;
a substrate placed in the fluid line on which bacteria can colonize;
a first at least one optical fiber having a distal end and a proximal end, said distal end being spaced a working distance from the probe to transmit bacteria autofluorescent excitation energy to the probe and said proximal end being in communication with an energy source that provides bacteria autofluorescent excitation energy to bacteria on the probe;
a second at least one optical fiber having a distal end and a proximal end said distal end being spaced a working distance from the probe to receive and transmit autofluorescence from the bacteria on the probe.

2. The apparatus of claim 1 further comprising a detector means at the proximal end of the second at least one optical fiber for detecting autofluorescence transmitted from the distal end.

3. The apparatus of claim 1 in which said first at least one optical fiber and said second at least one optical fiber are assembled in a bifurcated configuration such that their distal ends are substantially common and their proximal ends are independent.

4. The apparatus of claim 1 wherein said bacteria autofluorescence excitation energy from said source is in a range of wavelengths of about 340 nm to about 410 nm.

5. The apparatus of claim 4 said apparatus also including a short pass filter between said source and said probe.

6. The apparatus of claim 4 wherein said source of energy is an LED.

7. The apparatus of claim 4 wherein said source of energy is a laser.

8. Apparatus for the detection of bacteria in a fluid line having an interior wall, said apparatus including a bacteria probe in the fluid line, said probe being of a material and geometry to attract bacteria, said apparatus including an optical fiber having a distal and a proximal end, said distal end being located in energy coupled relationship to said probe at a characteristic working distance therewith.

9. Apparatus as in claim 8 also including a source of light of a frequency for interrogating said probe for the presence of bacterial there, said source being coupled to said proximal end.

10. Apparatus as in claim 9 also including a photodetector for detecting autofluorescent rumination from said probe responsive to interrogating light and indicative of the presence of bacteria.

11. Apparatus as in claim 10 wherein said optical fiber has a bifurcated geometry with first and second proximal ends and said source of light and said photodetector are coupled to said first and second proximal ends respectively.

12. Apparatus as in claim 9 wherein said source of light is a Led operative to emit light in a range of wavelengths of 340 to 410 nm, said apparatus also including a short pass filter between said source and said probe.

13. Apparatus as in claim 9 wherein said source of light is a laser operative to emit light in a range of wavelengths of 340 to 410 nm, said apparatus also including a short pass filter between said source and said probe.

14. Apparatus as in claim 10 wherein said photodetector is operative to measure NADH and/or NADPH emission having a peak between about 450 nm and about 460 nm by detecting the totality of light intensity in the wavelength range of 420 to 550 nm, said apparatus including a long pass (emission) filter between said photodetector and said probe.

15. Apparatus as in claim 8 wherein said optical fiber comprises a metallic collar at said distal end and guides therein for transmission of infra red energy to said collar for heating said collar.

16. A system including first and second apparatus each as set forth in claim 8, said system including means for diverting fluid flow from an on-line to an off-line subsystem responsive to a signal from the detector in said on-line subsystem indicating of the presence of bacteria on the probe in said on-line subsystem.

17. Apparatus for detecting the presence of bacteria in a fluid path, said apparatus comprising the placement of a bacteria probe in said fluid path, said probe including surface features of a geometry to attract bacteria.

18. Apparatus as in claim 17 wherein said features are crevices in a range of from about one to about one hundred nanometers.

19. Apparatus as in claim 18 wherein said crevices are arranged in a periodic pattern.

20. Apparatus as in claim 18 wherein said crevices are arranged in an aperiodic pattern.

21. Apparatus as in claim 17 also including means for eliminating bacteria accumulation on said probe.

22. Apparatus as in claim 17 including first and second fluid paths connected to a fluid source, said apparatus including a fluid diverter operative responsive to a first signal for diverting fluid flow from an on-line fluid path to an off-line fluid path, said fluid paths including first and second bacteria probes respectively and first and second sources of light of a frequency to excite bacteria for generating said first signal.

23. An apparatus for the detection of biofouling in a fluid line comprising;
a probe comprising a substrate placed in the fluid line on which bacteria can colonize;
a means for causing autofluorescence of bacteria on the probe;
a means for detecting the autofluorescence.

24. A method for detecting biofouling of a fluid line comprising;
placing a substrate in the fluid line for allowing colonization of bacteria on the substrate;
exposing the substrate to bacteria autofluorescence excitation energy;
detecting any autofluorescence.
providing an alternative subsystem and a diverter and operating the diverter to take the primary subsystem off line and replace it with the alternative subsystem when a level of bacteria is detected based on the intensity of the autofluorescence.
